(19) United States
(12) Patent Application Publication
(10) Pub. No.: US 2019/0224615 A1
(43) Pub. Date: Jul. 25, 2019

(54) APPARATUS AND PROCESS FOR PURIFYING SYNGAS

(71) Applicant: SHELL OIL COMPANY, HOUSTON, TX (US)

(72) Inventors: Rohit Ramesh REWAGAD, Rotterdam (NL); Jelle Sipke BOUMA, Rotterdam (NL)

(21) Appl. No.: 16/314,327

(22) PCT Filed: Jun. 27, 2017
(86) PCT No.: PCT/EP2017/065764

§ 371 Date: Dec. 28, 2018

(30) Foreign Application Priority Data
Jun. 28, 2016 (EP) 16176628.2

(51) Int. Cl. B01D 53/18; B01J 19/30; B01J 19/32; C10K 1/10; C10K 1/00; C10K 1/02; B01D 53/14; B01D 53/58

(52) U.S. Cl. CPC B01D 53/18; B01J 19/305; B01J 19/32; C10K 1/101; C10K 1/006; C10K 1/02; B01D 2257/408; B01D 53/58; B01D 2252/103; B01D 2256/16; B01D 2256/20; B01D 2257/406; B01D 53/1406

(57) ABSTRACT

The invention relates to an apparatus for purifying raw syngas which comprises a vertically oriented vessel comprising (a) a bottom section comprising an inlet for the raw syngas, an outlet for contaminants-rich water located below the inlet for raw syngas, a bed of a packing material located above the inlet for raw syngas and at least one inlet for water located above the bed of packing material and below the middle section; (b) a middle section located directly above the bottom section and fluidly connected with such bottom section comprising a number of separation trays corresponding with a number of theoretical stages in the range of from 8 to 20 and at least one inlet for water located above the separation trays; and (c) a top section located directly above the middle section and fluidly connected with such middle section comprising de-entrainment means, at least one inlet for water located above the de-entrainment means and an outlet for the purified syngas located above the inlet for water. The invention also relates to a process for purifying syngas using the apparatus described above.

### FIELD OF THE INVENTION

The present invention relates to an apparatus for purifying syngas comprising a bottom section for predominantly removing soot, a middle section for predominantly removing ammonia and hydrogen cyanide and a top section for de-entrainment and soot polishing. The invention also relates to a process for purifying syngas using such apparatus.

### BACKGROUND OF THE INVENTION

The expression “syngas” as used herein refers to synthesis gas, which is a common term to refer to gas mixtures comprising carbon monoxide and hydrogen.

Processes for the preparation of syngas are well known in the art. Typically a feed gas comprising methane is contacted with an oxidizing gas and the methane reacts with the oxidizing gas to form a syngas. Syngas produced by such known gasification processes contains impurities, in particular soot and nitrogenous impurities, such as ammonia (NH3) and hydrogen cyanide (HCN). Syngas can be used in a variety of chemical processes, in which it is converted in a desired product. Usually such conversion is a catalytic process, for example a Fischer-Tropsch process. Catalysts used in those conversion processes are often very sensitive to certain impurities in the syngas which would cause fouling (soot) and/or poisoning (NH3, HCN) of the catalyst used. Deactivation of the catalyst and selectivity loss, often irreversible, will occur as a result. Accordingly, it is important that impurities, such as soot, NH3 and HCN, are effectively removed from the syngas before using the syngas as feed in a catalytic conversion process.

Methods and devices for removing soot and/or NH3 and HCN from syngas are known in the art. For example, according to WO-2008/155305-A the NH3 and HCN are removed from the syngas by hydrolysis of HCN to NH3 at elevated temperature followed by passing the hydrolysed syngas over an acidic cation exchange resin in the presence of water to remove NH3.

WO-99/38795-A1 discloses a process for producing and cleaning a syngas. In this process most of the HCN is catalytically converted into NH3 which, along with some of the HCN, is subsequently removed from the syngas with water to form an aqueous solution of NH3 and HCN. The hydrocarbon gas feed to the synthesis gas generator is then used to strip NH3 and HCN from the aqueous solution of NH3 and HCN that was formed. In the syngas generator the NH3 and HCN are consumed to form clean water. A portion of the resulting clean water is recycled back into the process where it is used to scrub the synthesis gas, with the remainder used for other purposes or sent to disposal.

U.S. Pat. No. 4,189,307 discloses a process for producing clean HCN-free syngas from raw syngas leaving a partial-oxidation gas generator by a continuous process comprising the steps of partial cooling, scrubbing with condensate, cooling below the dew point by indirect heat exchange preferably with a rich liquid absorbent from a downstream acid-gas-removal zone, and scrubbing with cold aqueous absorbent. The HCN-containing aqueous absorbent resulting from this scrubbing step is then processed, for example, by stripping it or by reacting it in the gas generator. Optionally, other acid gases, if present, may be removed from the synthesis gas in said acid-gas-removal zone.

US-2012/0202897-A1 discloses a method for removing hydrogen sulphide and other impurities, such as NH3, COS, HCN and small alkali metal compounds from syngas obtained from gasification of a biomass feedstock. The method comprises contacting the syngas with an aqueous absorbent containing low levels of certain metal ions to absorb the impurities. US-2012/0202897-A1 refers in particular to sulphur compounds as impurities to be removed: the asorbed sulphur compound reacts with the metail ions in the aqueous absorbent to form metal sulphide precipitates. These precipitates can subsequently be removed from the absorbent by e.g. filtration. In one embodiment this method is carried out in a single vessel comprising three successive spray sections separated by sieve plates. The syngas enters the column via an inlet distributon in the bottom part and is countercurrently contacted with the aqueous absorbent containing the metal ions in the successive spray sections.

The apparatus and methods for removing soot and NH3/HCN (or other contaminants) from syngas as described in the prior art all require multiple vessels for removing the soot on the one hand and NH3/HCN on the other hand. Such vessels are typically operated at different temperatures and hence intermediate cooling steps are required. The present invention aims to provide an apparatus which enables the effective removal of soot, NH3 and HCN in a single vessel (scrubber column) at a single temperature, thereby eliminating the the need to maintain different temperatures and apply intermediate cooling steps.

### SUMMARY OF THE INVENTION

The present invention relates to an apparatus for purifying a syngas which comprises a vertically oriented vessel comprising a bottom section with an inlet for the raw syngas and a packing material for capturing soot, a middle section comprising a number of separation trays corresponding with such number of theoretical stages that NH3 and HCN are effectively removed and a top section comprising de-entrainment means and an outlet for the purified syngas. Bottom, middle and top section each comprise at least one inlet for water, while the bottom part of the bottom section comprises an outlet for contaminants-rich water.

The invention also relates to a process for purifying syngas, wherein (a) raw syngas is fed into the bottom section of the vertically oriented vessels that constitutes the apparatus of the present invention, (b) water having a temperature between 10 and 60° C. is fed into the top section, middle section and bottom section, (c) water containing the contaminants is collected at the bottom of the bottom section and (d) cleaned syngas is collected at the top of the top section.

The apparatus and process of the present invention have as an important advantage that the purification of the syngas can be carried out in a single scrubber column which is operated at a single temperature. Not only this eliminates the need for maintaining different operating temperatures for different stages of the purification, but it also reduces the total number of different equipment and utilities needed. Simplification of the operation reduces operating costs, whereas the reduced number of equipment and utilities required also reduce capital expenditure. Simpler operation also results in better process efficiency and hence better control of the purification process.

### DETAILED DESCRIPTION OF THE INVENTION

Accordingly, the present invention relates to an apparatus for purifying raw syngas which comprises a vertically oriented vessel comprising
(a) a bottom section comprising
   (a1) an inlet for the raw syngas,
   (a2) an outlet for contaminants-containing water located below the inlet for raw syngas,
   (a3) a bed of a packing material located above the inlet for raw syngas; and
   (a4) at least one inlet for water located above the bed of packing material and below the middle section;
(b) a middle section located directly above the bottom section and fluidly connected with such bottom section comprising
   (b1) a number of separation trays corresponding with a number of theoretical stages in the range of from 8 to 20; and
   (b2) at least one inlet for water located above the separation trays; and
(c) a top section located directly above the middle section and fluidly connected with such middle section comprising
   (c1) de-entrainment means;
   (c2) at least one inlet for water located above the de-entrainment means; and
   (c3) an outlet for the purified syngas located above the inlet for water.

The inlet for the raw syngas in the bottom section of the vertically oriented vessel comprises conduit extending through the vessel wall which is fluidly connected to a gas feed inlet device that achieves an even distribution of the raw syngas across the cross section of the bottom section, so that it can be effectively contacted with the water. Such gas feed inlet device may also perform a first separation of any solids and/or liquids entrained in the syngas and decrease the momentum of the syngas. By decreasing the momentum, the velocity of the raw syngas entering the bed of packing material is decreased which enables a more effective contact with the water inside the packed bed. This, in return, improves soot removal and heat transfer from the raw syngas to the water. In a preferred embodiment the inlet for the raw syngas in the bottom section comprises a vane feed inlet device. An example of a suitable vane feed inlet devive is the Shell Schoepentoeter™ vane inlet device.

The bottom section bottom comprises a bed of packing material to enable efficient contact between the water and the raw syngas, so that heat contained in the raw syngas is effectively transferred to the water (i.e. cooling of the raw syngas) and any soot particles contained in the raw syngas can be effectively captured by water droplets condensing on such soot particles. This will enable the removal of such soot particles with the contaminants-rich water via the outlet for such water located at the bottom part of the bottom section below the inlet for raw syngas. In addition, the packing material should also be suitable to enable removal of at least some of the NH3 and HCN contained in the raw syngas.

Suitable packing materials are known in the art. For the purpose of the present invention it was found that particularly suitable packing materials for the bottom section are those packing materials having a HETP for NH₃/HCN removal in the range of from 0.8 to 2.2 meter, more preferably from 1.2 to 2.0 meter. In addition, the number of theoretical stages for NH3/HCN removal in the entire packed bed is suitably in the range of from 2 to 10, more suitably from 3 to 8.

The term “HETP” is a parameter for distillation and separation equipment and packing materials that is well known in the art. “HETP” stands for Height Equivalent to a Theoretical Plate and is equal to the actual height of the bed of packing material divided by the number of theoretical plates (also referred to as theoretical stages) provided by the packing material in question. The HETP of a particular packing material varies with the compounds or substances that need to be separated. For example, the HETP of a packing material for separating hydrocarbons in a gas stream will be different from the HETP of the same packing material for separating NH3/HCN from a gas.

The packing material used in the bottom section may be a random packing material or a structured packing material. Both are well known. For the purpose of the present invention it was found that a bed of random packing material is preferred in the bottom section. Suitable random packing material can have a variety of different shapes, all intended to optimize the contact between water and syngas in order to improve the heat transfer, and thereby the condensation of water droplets onto the soot particles present in the raw syngas, and absorption of NH3/HCN in the water.

The bed of packing material is located above the raw syngas inlet, so that in operation the syngas can flow upwardly into the bed of packing material. Water flowing down through the bed of packing material in the bottom section comes from the middle and top section, but also from at least one water inlet located between the bed of packing material and the middle section. The water inlet should uniformly distribute the water at the top of the bed of packing material. Therefore, the water inlet suitably comprises a pipe extending through the wall of the vertically oriented vessel which pipe is fluidly connected with a liquid distributor. For the purpose of the present invention the liquid distributor should provide sufficient gas passage area to enable the raw syngas to flow upwardly without a high pressure drop or high liquid entrainment. Such distributors are known in the art. Examples of suitable distributors are gravity distributors and pressure (spray) distributors. For the purpose of present invention a gravity distributor is preferably used as part of the water inlet in the bottom section.

Where in the bottom section the heat transfer is a predominant factor in determining the internals used, in the middle section the removal of NH3 and HCN determines the internals. The middle section, accordingly, comprises separation trays and an inlet for water above such trays to enable the effective removal of NH3 and HCN to very low levels (usually in the order of less than 10 ppbv of each). The separation trays should enable the effective absorption of NH3 and HCN by the water that flows through the separation trays and hence should maximize contact between upwardly flowing syngas and downwardly flowing water.

It was found that the number of separation trays used in the middle section should correspond with a number of theoretical stages in the range of from 8 to 20, preferably 10 to 18. The type of separation trays used can vary widely. Examples of suitable tray types include fixed valve trays, sieve trays and floating valves. It was found, however, that fixed valve trays work very well and in particular fixed valve trays of the V-grid type. The V-grid helps to keep the tray surface clean and hence prevents fouling.

The water inlet of the middle section could again be a gravity distributors or pressure (spray) distributors, but in this case a pressure spray distributor is preferred.

The top section is designed to “polish” the syngas, i.e. to remove the last traces of soot from the syngas and hence to minimize soot carry-over and thereby fouling of equipment that is used downstream of the apparatus of the present invention. Furthermore, in the top section any entrained liquid droplets are separated from the syngas (de-entrainment). In order to achieve the soot polishing and de-entrainment the top section comprises de-entrainment means. Such de-entrainment means should again maximize contact between water introduced in the top part of the top section and the upwardly flowing syngas. Suitable de-entrainment means would be a bed of a random packing material or one or more layers of a structured packing material, both known in the art. Alternatively, one or more layers of separation trays, such as the fixed valve trays suitably used in the middle section, may be used. For the purpose of the present invention it was, however, found particularly suitable to use de-entrainment means which comprise at least one layer of a structured packing material, preferably between 1 and 8 layers and more preferably between 2 and 6 layers of such structured packing material.

Structured packing materials are known in the art for use in absorption and distillation operations. They typically consist of thin corrugated metal plates arranged such that fluids have to take long and complicated paths through the structure, thereby maximizing the surface area for contact between different phases. Well know examples include the MellapakTM series of structured packing materials.

In the top section no or hardly any mass transfer occurs, the main purpose is effectively contacting the water with the upwardly flowing syngas to remove the last traces of soot and any entrained liquid droplets and to mitigate any entrainment of water droplets in the syngas. The water inlet located above the de-entrainment means, therefore, should uniformly distribute the water over the de-entrainment means. For that purpose it was found particularly suitable to use a water inlet that comprises a splash type gravity distributor fluidly connected to a pipe that extends through the wall of the vertically oriented vessel.

The purified syngas leaves the apparatus for purifying the syngas via an outlet located above the water inlet in the top section.

The top section may optionally comprise further means for removing any last traces of any entrained liquid droplets, suitably in the form of a demister. Such demister would be located in the top of the top section, between the water inlet and the syngas outlet. Demisters are known in the art and include, for example, a demister mesh, a vane pack, a mist mat or a swirl tube cyclone deck.

The present invention also relates to a process for purifying a raw syngas comprising the steps of
(a) feeding the raw syngas to the bottom section of the vertically oriented vessel of the apparatus according to the invention as described above;
(b) feeding water having a temperature between 10 and 60° C., preferably 20 to 50° C., into the top section, middle section and bottom section of the vertically oriented vessel;
(c) collecting the water containing the contaminants at the bottom of the vertically oriented vessel; and
(d) collecting the cleaned raw syngas at the top of the vertically oriented vessel.

The raw syngas is typically fed into the bottom section of the purification apparatus at an inlet temperature in the range of from 110 to 200° C., preferably 120 to 180° C., and a pressure in the range of from 35 to 80 bar, preferably 45 to 60 bar. Typically here will be hardly any pressure drop when the syngas passes through the purification apparatus, so the outlet pressure of the syngas in step (d) of the process will be the same as or similar to the inlet pressure. The temperature of the syngas will decrease, as it passes through the various sections of the purification apparatus, because it is contacted with water of a lower temperature in step (b). Hence, a transfer of heat occurs. The temperature of the syngas leaving the purification apparatus in step (d) will usually be between 50 and 100° C. lower than the temperature of the raw syngas at the inlet and will be in the range of from 30 to 130° C., preferably 40 to 100° C.

The water streams that enter the apparatus in the bottom, middle and top section will have a temperature between 10 and 60° C., preferably 20 to 50° C. Water obtained elsewhere in the syngas manufacturing process or in the process in which the syngas is used can be used as the source of these water streams. For example, boiler feed water could be used. For the purpose of the present invention it was found that the contaminants-containing water collected at the bottom can be effectively recycled for use in the middle and/or bottom section. The water stream entering the top section preferably is non-recycled water, such as the aforesaid boiler feed water.

Accordingly, in a preferred embodiment the water containing the contaminants which is collected at the bottom of the vertically oriented vessel is cleaned in at least one stripper and at least part of the cleaned water obtained is recycled to be fed into the middle section in step (b). Usually one stripper will suffice to clean the contaminated water. This recycled water may also be used in the bottom section. Because the contaminants-containing water collected at the bottom section will have a higher pressure than the pressure in the stripper, a flash vessel is suitably used before the stripper to collect the contaminants-containing water and to reduce the pressure.

In an alternative embodiment no prior treatment in a stripper of all or part of the water introduced into the bottom section takes place before it is recycled back into this bottom section. In fact, in a preferred embodiment of the present invention part of the contaminants-containing water collected at the bottom of the vertically oriented vessel is directly recycled to the bottom section in step (b). Because the contaminants-containing water collected at the bottom of the purification apparatus has been warmed up by its contact with the warm syngas, it has to be cooled to the desired temperature during the recycle, suitably by indirect heat exchange against another process stream or by a cooled pump which simultaneously cools and pumps around the water.

### BRIEF DESCRIPTION OF THE DRAWING

FIG. 1 shows a schematic drawing of an apparatus according to the present invention.

### DETAILED DESCRIPTION OF THE DRAWING

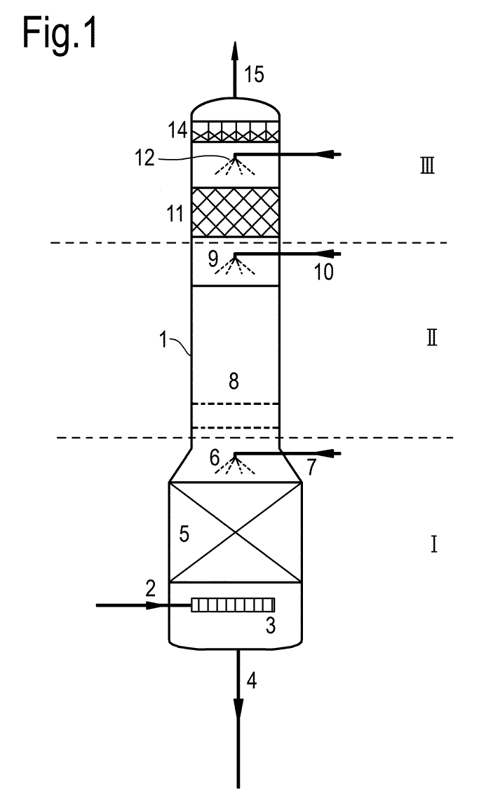

As shown in FIG. 1 the raw syngas gas enters the bottom section I of vertically oriented vessel 1 at synges inlet 2 and is distributed into the bed of random packing material 5 via vane feed inlet device 3. Contaminants-containing water leaves the bottom section I via outlet 4. Water enters the bottom section I via water inlet 7 and is distributed over the bed of random packing material 5 through liquid distributor 6. When in operation, the syngas enters the separation trays 8 in the middle section II where it is contacted with water entering the middle section II at water inlet 10 and is distributed over the separation trays 8 through liquid distributor 9. Syngas coming from the separation trays 8 then flows into de-entrainment section 11 of the top section III, where it is contacted with water entering the top section III via water inlet 13 and distributed through liquid distributor 12. In the embodiment shown in FIG. 1 the top section III also contains demister 14. Purified syngas leaves the top section III via syngas outlet 15.

1. An apparatus for purifying raw syngas which comprises a vertically oriented vessel comprising
(a) a bottom section comprising
(a1) an inlet for the raw syngas,
(a2) an outlet for contaminants-containing water located below the inlet for raw syngas,
(a3) a bed of a packing material located above the inlet for raw syngas; and
(a4) at least one inlet for water located above the bed of packing material and below the middle section;
(b) a middle section located directly above the bottom section and fluidly connected with such bottom section comprising
(b1) a number of separation trays corresponding with a number of theoretical stages in the range of from 8 to 20; and
(b2) at least one inlet for water located above the separation trays; and
(c) a top section located directly above the middle section and fluidly connected with such middle section comprising
(c1) de-entrainment means;
(c2) at least one inlet for water located above the de-entrainment means; and
(c3) an outlet for the purified syngas located above the inlet for water.

2. The apparatus according to claim 1, wherein the inlet for the raw syngas in the bottom section comprises a vane feed inlet device.

3. The according to claim 1, wherein the packing material in the bottom section has a HETP for NH₃/HCN removal in the range of from 1.2 to 2.0 meter corresponding with a number of theoretical stages in the range of from 2 to 10.

4. The apparatus according to claim 1, wherein the packing material in the bottom section is a random packing material.

5. The apparaturs according to claim 1, wherein the number of separation trays in the middle section corresponds with a number of theoretical stages in the range of from 10 to 18.

6. The apparatus according to claim 1, wherein the separation trays in the middle section are fixed valve trays.

7. The apparatus according to claim 1, wherein the de-entrainment means in the top section comprise at least one layer of a structured packing material.

8. A process for purifying a raw syngas comprising the steps of
(a) feeding the raw syngas to the bottom section of the vertically oriented vessel of the apparatus;
(b) feeding water having a temperature between 10 and 60° C. into the top section, middle section and bottom section of the vertically oriented vessel;
(c) collecting the water containing the contaminants at the bottom of the vertically oriented vessel; and
(d) collecting the cleaned raw syngas at the top of the vertically oriented vessel.

9. The process according to claim 8, wherein the water containing the contaminants and collected at the bottom of the vertically oriented vessel is cleaned in at least one stripper and at least part of the cleaned water obtained is recycled to be fed to the middle section in step (b).

10. The process according to claim 9, wherein the water containing the contaminants and collected at the bottom of the vertically oriented vessel is partly recycled to be fed into the bottom section in step (b).
